(19) United States
(12) Patent Application Publication
(10) Pub. No.: US 2018/0110010 A1
(43) Pub. Date: Apr. 19, 2018

(54) EXTENDING BATTERY LIFE IN LOW SIGNAL CONDITIONS

(71) Applicant: Microsoft Technology Licensing, LLC, Redmond, WA (US)

(72) Inventors: Jean Khawand, Sammamish, WA (US); Srinivasa L. Rao, Redmond, WA (US); Mahesh Yadav, Redmond, WA (US)

(21) Appl. No.: 15/297,866

(22) Filed: Oct. 19, 2016

(51) Int. Cl. H04W 52/02; H04W 24/08; G06F 3/0482

(52) U.S. Cl. CPC H04W 52/0264; G06F 3/0482; H04W 52/0254; H04W 24/08

(57) ABSTRACT

Power usage on a computing device is managed. Data indicative of signal or network conditions for a network for which the system is communicatively coupled via a communications link is accessed. The link quality for the communications link is determined. Based on the determined link quality, applications are allowed or delayed for a period of time to access the network for communication. The applications are selected so as to reduce power consumed by the system based on the determined link quality.

### BACKGROUND

In a wireless network such as a cellular network, the link quality between a device and the network may vary in bandwidth, latency and/or loss. The quality may be affected by signal quality, interference, network issues, and the like. Exchanging data over a poor quality link could result in prolonged use of the cellular network resources and consume power longer than expected. Wireless devices also have limited power storage capacity and excessive power usage can drain the battery of the wireless device.

### SUMMARY

In various embodiments, methods and systems are disclosed for managing power usage on a computing device. Data indicative of signal or network conditions for a network for which the system is communicatively coupled via a communications link is accessed. The link quality for the communications link is determined. Based on the determined link quality, applications are selected that are allowed to be executed by the system. The applications are selected so as to reduce power consumed by the system based on the determined link quality.

It should be appreciated that the disclosed subject matter may be implemented as a computer-controlled apparatus, a computer process, a computing system or device, or as an article of manufacture such as one or more computer-readable storage media. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an example system wherein aspects of the present disclosure can be implemented.

FIG. 2 illustrates a computer system wherein aspects of the present disclosure can be implemented.

FIG. 3 depicts an operational environment for practicing aspects of the present disclosure.

FIG. 4 illustrates an example process for managing power usage on a computing device in accordance with the present disclosure.

### DETAILED DESCRIPTION

In a network where wireless devices such as a mobile phone are in communication, the wireless devices may establish wireless links via the network. If a wireless link is part of a network within a controlled area, for example, a workspace infrastructure, then typically the bandwidth is predictable and reliable. But in a wide area network, the connection may encounter a number of interference sources, and network devices and bandwidth may be restricted at various points. The result is that the available bandwidth and latency is unpredictable and in some cases insufficient to adequately support a usable connection session. Smartphones and other mobile devices that frequently synchronize data over the air via a cellular network typically exhibit poor battery life when operating in marginal signal conditions. The battery life may also suffer due to heavy network loading, and may be further exacerbated when the device goes in and out of service due to the marginal signal conditions.

Mobile devices in use today (e.g., tablets, smartphones, laptops, etc.) typically have built-in applications such as email auto-synchronization, cloud backups, and social networking applications that are configured to attempt transfers of data without any consideration of the associated power drain. Many of these applications will attempt data transfers aggressively and without regard to the device's battery levels and power usage. Such data transfers typically occur without the user's knowledge and will end up draining the device's battery. The users may thus have the negative experience of the fast draining of their device's battery without the user actively operating the device. Various embodiments of the present disclosure may allow for enhancement of the user experience by allowing access to the data network by a device while minimizing the battery drain.

Described herein are methods and systems for extending battery life in low signal conditions based in link reliability. Techniques described herein may be implemented for devices in communication with various wireless communications systems such as CDMA, TDMA, FDMA, OFDMA, and SC-FDMA. A CDMA system may implement a radio technology such as CDMA2000, Universal Terrestrial Radio Access (UTRA), etc. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. The techniques described herein may be used for the systems and radio technologies mentioned above as well as other systems and radio technologies. The description below, however, describes a cellular system for purposes of example, although the techniques are applicable beyond cellular applications.

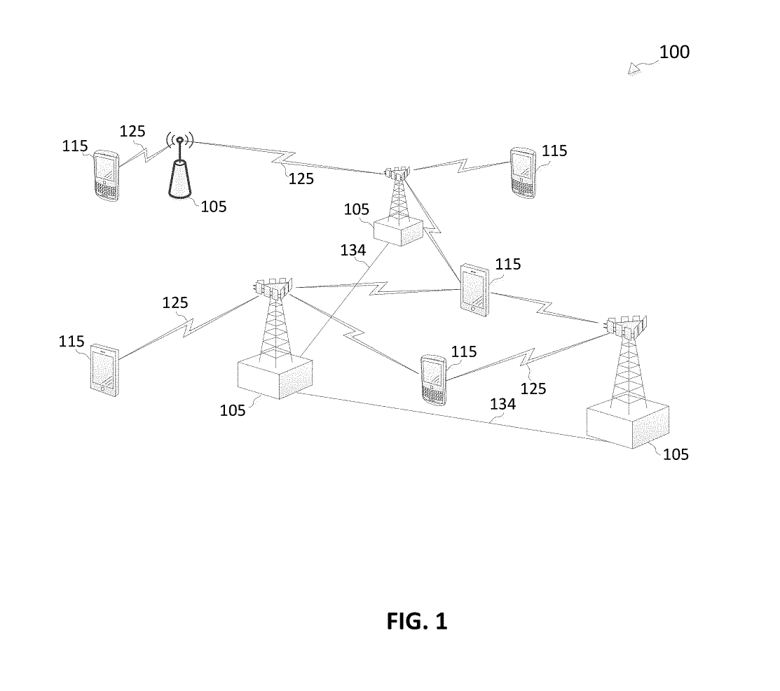

FIG. 1 is a block diagram conceptually illustrating an example of a wireless communications system 100, in accordance with an aspect of the present disclosure. The wireless communications system 100 includes base stations (or cells) 105 and mobile devices 115. The base stations 105 may communicate with the mobile devices 115 under the control of a base station controller (not shown), which may be part of a core network or the base stations 105. The wireless communications system 100 may support operation on multiple carriers. Multi-carrier transmitters can transmit modulated signals simultaneously on the multiple carriers. For example, each communication link 125 may be a multi-carrier signal modulated according to the various radio technologies described above.

The base stations 105 may wirelessly communicate with the mobile devices 115 via one or more base station antennas. The base stations 105 sites may provide communication coverage for respective coverage areas. The mobile devices 115 may be located throughout the wireless communications system 100 and may be stationary or mobile. A mobile device 115 may also be referred to as user equipment (UE), mobile station, a mobile unit, a subscriber unit, remote unit, a mobile device, a wireless communications device, a remote device, a mobile terminal, a wireless terminal, a handset, a mobile client, a client, or other suitable terminology. A mobile device 115 may be a cellular phone, a wireless modem, a wireless communication device, a handheld device, a tablet computer, a laptop computer, or the like. The communication links 125 shown in the wireless communications system 100 may include uplink (UL) transmissions from a mobile device 115 to a base station 105, and/or downlink (DL) transmissions, from a base station 105 to a mobile device 115.

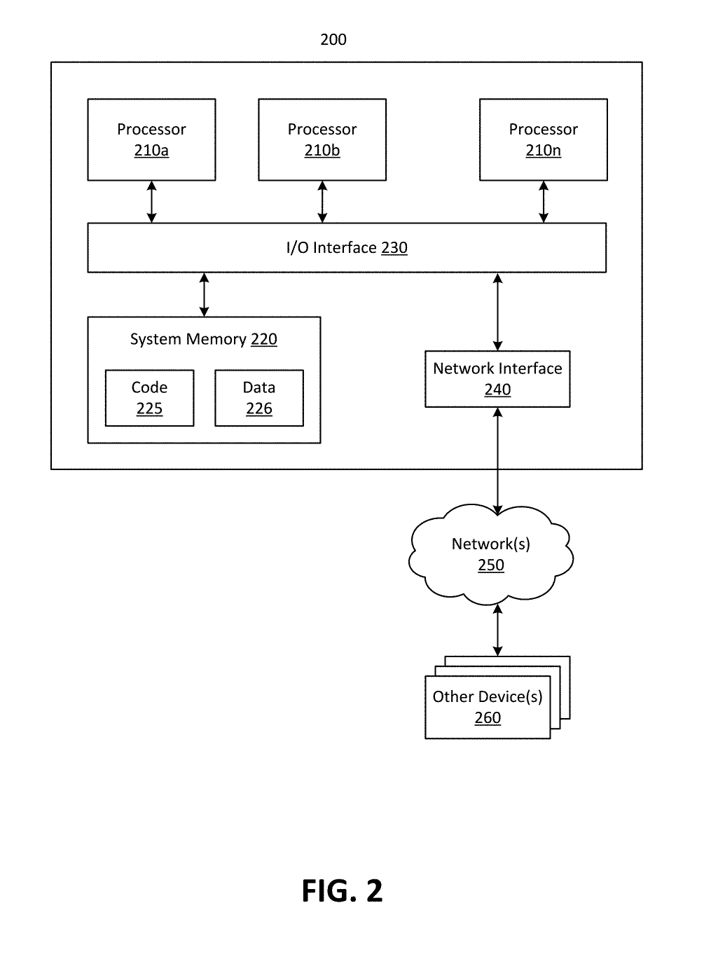

In at least some embodiments, a computing device that implements a portion or all of one or more of the technologies described herein, including techniques to implement power management functionality of a device, may include a general-purpose computer system that includes or is configured to access one or more computer-accessible media. FIG. 2 illustrates such a general-purpose computing device 200. In the illustrated embodiment, computing device 200 includes one or more processors 210a, 210b, and/or 210n (which may be referred herein singularly as “a processor 210” or in the plural as “the processors 210”) coupled to a system memory 220 via an input/output (I/O) interface 230. Computing device 200 further includes a network interface 240 coupled to I/O interface 230.

In various embodiments, computing device 200 may be a uniprocessor system including one processor 210 or a multiprocessor system including several processors 210 (e.g., two, four, eight, or another suitable number). Processors 210 may be any suitable processors capable of executing instructions. For example, in various embodiments, processors 210 may be general-purpose or embedded processors implementing any of a variety of instruction set architectures (ISAs), such as the x86, PowerPC, SPARC, or MIPS ISAs, or any other suitable ISA. In multiprocessor systems, each of processors 210 may commonly, but not necessarily, implement the same ISA.

System memory 220 may be configured to store instructions and data accessible by processor(s) 210. In various embodiments, system memory 220 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 220 as code 225 and data 226.

In one embodiment, I/O interface 230 may be configured to coordinate I/O traffic between processor 210, system memory 220, and any peripheral devices in the device, including network interface 240 or other peripheral interfaces. In some embodiments, I/O interface 230 may perform any necessary protocol, timing, or other data transformations to convert data signals from one component (e.g., system memory 220) into a format suitable for use by another component (e.g., processor 210). In some embodiments, I/O interface 230 may include support for devices attached through various types of peripheral buses, such as a variant of the Peripheral Component Interconnect (PCI) bus standard or the Universal Serial Bus (USB) standard, for example. In some embodiments, the function of I/O interface 230 may be split into two or more separate components, such as a north bridge and a south bridge, for example. Also, in some embodiments some or all of the functionality of I/O interface 230, such as an interface to system memory 220, may be incorporated directly into processor 210.

Network interface 240 may be configured to allow data to be exchanged between computing device 200 and other device or devices 260 attached to a network or network(s) 250, such as other computer systems or devices as illustrated in FIGS. 1 through 11, for example. In various embodiments, network interface 240 may support communication via any suitable wired or wireless general data networks, such as types of Ethernet networks, for example. Additionally, network interface 240 may support communication via telecommunications/telephony networks such as analog voice networks or digital fiber communications networks, via storage area networks such as Fibre Channel SANs or via any other suitable type of network and/or protocol.

In some embodiments, system memory 220 may be one embodiment of a computer-accessible medium configured to store program instructions and data as described herein for FIGS. 1, 3, and 4 for implementing embodiments of the corresponding methods and systems. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 200 via I/O interface 230. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 200 as system memory 220 or another type of memory. Further, a computer-accessible medium may include transmission media or signals such as electrical, electromagnetic or digital signals, conveyed via a communication medium such as a network and/or a wireless link, such as may be implemented via network interface 240. Portions or all of multiple computing devices, such as those illustrated in FIG. 2, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices. For purposes of this specification and the claims, the phrase “computer-readable storage medium” and variations thereof, does not include waves, signals, and/or other transitory and/or intangible communication media.

A network set up by an entity, such as a company or manufacturer, to provide one or more services (such as various types of cloud-based analytics services) accessible via the Internet and/or other networks to a distributed set of clients may be termed a service provider. Such a provider network may include numerous data centers hosting various resource pools, such as collections of physical and/or virtualized computer servers, storage devices, networking equipment, and the like, needed to implement and distribute the infrastructure and services offered by the service provider.

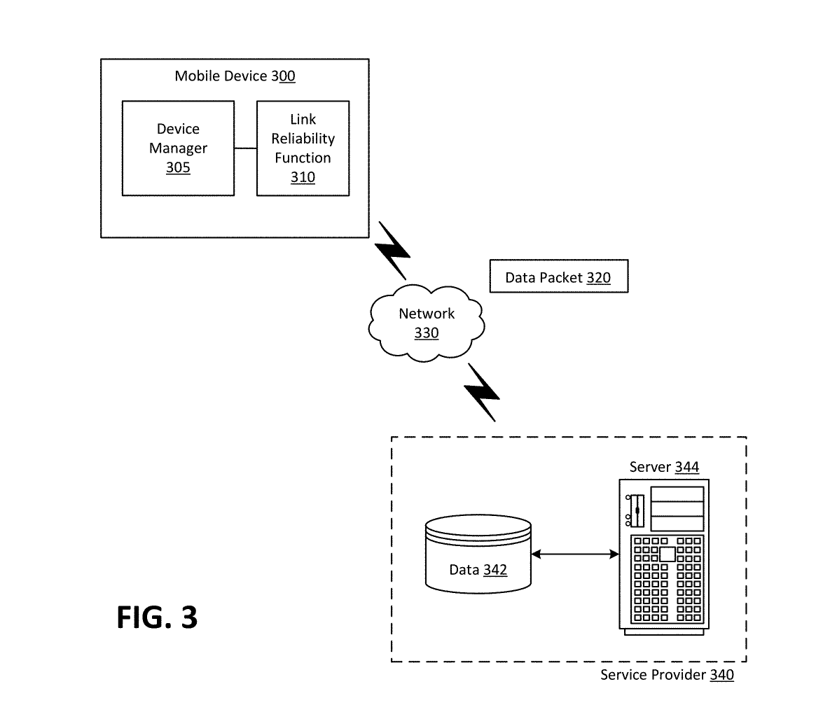

Described herein are methods and systems for extending battery life in low signal conditions based in link reliability. These and other aspects and embodiments of the present invention will now be described in greater detail. FIG. 3 illustrates one embodiment of a system for managing power of a computing device in accordance with the present disclosure. The system comprises a mobile device 300. The mobile device 300 communicates with a service provider 340 via a communications network 330. The mobile device 300 includes a device manager 305 and a link reliability function 310. The service provider 340 may include a server 344 and database 342 for storing data that may be accessed by mobile device 300.

The mobile device 300 can be a smart phone, a personal computer, laptop, or any other computing device that includes wired or wireless communication capabilities. The link reliability function 310 can be a software application that executes on mobile device 300, as further described herein.

The communications network 330 may be a Local Area Network (LAN), a larger network such as a Wide Area Network (WAN), or a collection of networks such as the Internet. Communications network 330 may, for example, be a publicly accessible network of linked networks and possibly operated by various distinct parties, such as the Internet. In other embodiments, communications network 330 may be a private network, such as, for example, a corporate or university network that is wholly or partially inaccessible to non-privileged users. In still other embodiments, communications network 330 may include one or more private networks with access to and/or from the Internet.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that the link reliability function 300 described in FIG. 3 is merely illustrative and that other implementations might be utilized. Additionally, it should be appreciated that the functionality disclosed herein might be implemented in software, hardware, or a combination of software and hardware. Other implementations should be apparent to those skilled in the art. It should also be appreciated that a computing device may comprise any combination of hardware or software that can interact and perform the described types of functionality, including without limitation laptop or other computers, tablets, cellphones, wireless phones, Internet appliances, television-based systems, and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

Mobile devices in use today (e.g., tablets, smartphones, laptops, etc.) typically have built-in applications and functions such as email auto-synchronization, cloud backups, and social networking applications that are configured to attempt data transfer without any consideration of the associated power drain. Many of these applications will attempt data transfers aggressively and without regard to the battery levels and power usage. Such data transfers typically occur without the user's knowledge and may drain the device's battery. The users may then complain about the early draining of their device's battery without the user actively operating the device.

When a device is attempting to access the data network during marginal conditions, the device typically consumes much higher power due to a number of factors. For example, the power amplifier of the device may operate at a maximum or close to the maximum transmit power. Additionally, retransmissions due to poor signal conditions may extend the time it takes to transmit a fixed amount of data, resulting in the device components (e.g., application processor, modem, transceiver, memory) being active for longer than would be necessary in better signal conditions. A network that is exhibiting lower network bandwidth may also extend the time it takes to transmit a fixed amount of data by the device.

Furthermore, when the device transitions in and out of service and frequently disconnects, many applications may attempt to re-establish data sessions and restart data transfers that were previously aborted, further causing a greater amount of power draw from the battery.

In embodiments of the disclosure, operating conditions of the network may be gathered along with other factors from the device such as, for example, signal quality, transmission statistics (TCP, data link, actual throughput), network transitions, temperature, battery levels, charging state, and time of day. Based on the data, access to the data network by the device may be controlled. This controlled access may allow for the battery life to be extended. In some embodiments, the battery life may be extended without significantly affecting the data services or without impacting the user experience. In some embodiments, the user may be informed of the network conditions and allowed to select one or more options for response. For example, the user may be prompted to override the automatic network control, or to plug the device to a charger so that data transfer may continue uninterrupted.

In an embodiment, parameters from different operating subsystems of the device may be collected. The collected information may be provided to one or more systems configured to analyze the collected information. The system may be referred to herein as a link reliability function. In one embodiment, the link reliability function may be configured to determine a parameter referred to herein as a connection reliability indicator (CRI). The link reliability function may also be configured to determine a parameter referred to herein as a back-off support parameter (BSP). The link reliability function may include a connection back-off algorithm to determine a network access back-off (NAB) timer.

In an embodiment, the connection reliability indicator may be determined by a system or device executing the link reliability function. In one embodiment the link reliability function may be configured to receive data indicative of one or more network states and signal quality. The link reliability function may apply the received data to a cellular or network operations behavior model to determine the connection reliability indicator.

In an embodiment, the connection reliability indicator may be implemented as a numerical representation indicated by four categories (0, 1, 2, or 3).

CRI=3 may indicate that the cellular data link is highly reliable and that network disconnects are not anticipated;

CRI=2 may indicate that the cellular data link is moderately reliable and that some network disconnects can be expected;

CRI=1 may indicate that the cellular data link is unreliable and that a disconnect can be expected at any time;

CRI=0 may indicate that the cellular data link is such it is not worth establishing a data connection.

These numerical representations are examples and the number of indicators can be extended to provide more granular information about the reliability of the data link. Alternatively the number of numerical representations may be reduced to provide a lesser number of indications as needed by the specific implementation. The indicators can include situations were a wireless device has service and is connected to the network, but where the quality of the network may be characterized in order to allow the device to reduce power consumption due to the link conditions. The CRI may also be provided to the back-off algorithm that is configured to determine the back-off time.

In an embodiment, the link reliability function may include a network state function that is configured to collect information related to cellular network connectivity such a service status (e.g., in-service, out-of-service), frequency of disconnects, network mobility and radio technology transitions, and system selection/determination timeouts. The network state function may continually capture the network state information for processing by the link reliability function.

In an embodiment, the link reliability function may include a signal quality function that is configured to collect radio frequency (RF) signal information such as the Received Signal Strength Indication (RSSI), Signal-to-Noise Ratio (e.g., CINR), short and long fades, transmit power samples, and cumulative distribution factor (CDF) for transmit and receive power. The information can be used in raw form, or can be processed (e.g., averaged) from RF modules as needed by the link reliability function. This data may be continuously captured for processing by the link reliability function.

In some embodiments, additional modules can be implemented to provide functions that monitor information such as the battery level, charger state, and device operating temperature. A battery level function may be configured to collect information about the currently battery voltage level and discharge rate over a period of time. The period of time may be set to help determine a suitable back-off time. The period of time may also be set to allow for sufficient weighting to enable a determination of whether a connection should be established.

A charger state function may be configured to provide information regarding whether the battery charger is connected and information about the battery charging rate. A device operating temperature function may be configured to collect information regarding the device temperature, which may be used to help determine conditions regarding data connectivity and higher transmitter power.

The data polling frequency can be varied from seconds to minutes or some other frequency. The frequency of data collection for the various parameters may be dynamically changed to gather data at lower or higher sample rates under various conditions.

In an embodiment, the link reliability function may include a datagram statistics module that is configured to collect data transmission statistics at the physical layer, data link layer, and/or transport/IP layers. Physical layer statistics such as the Bit Error Ratio (BER), Block Error Ratio (BLER), Frame Error Rate (FER), Automatic Repeat Request (ARQ) state, hybrid automatic repeat request (HARD), and forward and reverse packet rate may also be collected. Data link layer statistics that are collected may include retransmitted rate, round trip time, consecutive erasures, number of resets, NAK aborts, block bytes, blank frames, idle frames, retransmitted frames, NAK counts, duplicate bytes, and retransmission undetected bytes. Transmission control statistics that are collected may include failed connection attempts, segments sent, segments received, retransmitted, error received, segments with reset, and dropped packets. The error and success rates as monitored over a period of time may be weighted to determine the connection reliability. Additionally, errors at each layer may be used to determine correlations with network states and signal quality.

In some embodiments, the link reliability function may implement a device operating mode detection module that is configured to determine whether requested data can be supported and to determine back-off support parameters (BSP).

In some embodiments, the time of day may be used as a factor by the link reliability function to weight the back-off period that can be applied based on the device usage. The time of day may also be used to identify patterns for the device over a period of time. The period of time may also be adaptable.

In some embodiments, the user may be provided a notification regarding the CRI and other operating parameters pertaining to the link conditions. The user may also be provided suggestions as to whether the device should continue to operate on the network given the current link conditions, in order to reduce drain on the battery. In some embodiments, based on the determined CRI, the device may establish various operational modes which may be initiated automatically or as selected by the user. For example, an operational mode can be established so that only selected sessions such as email applications are allowed to continue. The applications that are allowed to continue operation may be selected by the user or can be predefined according to a prioritization scheme. Selected operations that require significant network resources such as large uploads and downloads may be suspended by user action or according to the prioritization scheme. The user may also be notified that the device should be plugged into the charger. The user may thus be notified of the device operating conditions and how the battery life will be impacted based on the device's location and network conditions.

The various parameters described above may be provided to the link reliability function which may be implemented as one or more functions or systems.

Both the CRI and the BSP can be used by a back-off algorithm to determine a connectivity back-off timer or a network access back-off (NAB) timer. Depending on the how the parameters of the CRI and BSP are weighted, the connectivity back-off timer or a NAB timer can either be increased uniformly or telescopically to control network access in order to save battery consumption while reducing impact to the user experience.

In one embodiment, an algorithm for determining the connection reliability indicator and back-off time can be implemented as a function, remote procedure call, or as a service in the OS with the notification manager. In an example implementation, three functions may be provided as follows:

1. Gather various link statistics

2. Determine the CRI (Connection Reliability Indicator)

3. Determine Back-off Timer based on the CRI

Function 1

```
      // Function for gathering the current statistics of the different parameters
      // The capturing modules can be hardware or software. This can be a service that
can register for events from each of the lower layer reports. A sample single iteration is
shown below.
      Function : GatherLinkStatistics ( )
      {
      // the lower level RF modules monitor and average the RSSI based on the
requested timer and report back the Rssi.s per the specific timer and return the Rssi
        Rssi = CaptureRssiRange (RssiAveraging_time:Sec)
      // the lower level RF modules monitor and average the CQI for as per the specific
timer and return the Rssi
        CQI = CaptureCQIRange (CQIAveraging_time:Sec)
      // The Low level modules to capture and average the BER (Bit Error Rate of the
radio Link)
      BER = CaptureBERRange(BERAverage_Time:Sec
      // likewise capture the links status for all the parameters defined in the disclosure.
      }
```

### Function to Determine CRI for Each Parameter

Function 2

```
StructCRI DetermineIndividualCRI(Rssi, CQI, BER ... )
{
  // Determine the CRI for each parameter based on the range of the values
  // Determine the RssiCRI based on the different range of the RSSI values
  RssiCRI = 3 // assume the CRI as high reliability
  if (Rssi < −105dbm )
  {
    RssiCRI = 0
  }
  else if ( Rssi range between −90dBm ..−105dBm)
  {
    RssiCRI = 1
  }
  else if ( Rssi Range Range between −70dBm .. −90dBm)
  {
  RssiCRI = 2
  }
  StructCri.RssiCri = RssiCri
// Determine the CqiCRI based on the CQI
  CqiCRI = 3 // Assume best CQI
  if (Cqi Range between 1..6)
  {
    CqiCRI = 0
  }else if (Cqi Range between 7..9)
  {
  CqiCRI = 1
  }else if (Cqi Range between 10..12)
  {
  CqiCRI = 2
  }
  StructCri.CqiCRI = CqiCRI
// continue to map the CRI for each of the parameters
Return(StructCri)
}
```

### Function to Calculate the Backoff Timer

Function 3

```
      CalulateBackofTimer(StructCri : Carries all the individual Parameters )
      {
      // Using the individual CRI, find the final CRI based on the different priorities
or weight each CRI carries in making a decision
      CRI = CalculateFinalCRI(pass all the individual CRIs : RssiCRi, CQiCri,
BERCri..)
      If (CRI = 0)
      {
        BackofTimer = MAX_BACKOFF // MAX Back off for ex: 30 mins
      } else if (CRI=1)
      {
        BackofTimer = UNREL_BACKOFF // Unreliable Back off for ex: 20 mins
      } else if (CRI = 2)
      {
        BackoffTimer = MOD_BACKOFF // Moderate Back off, for ex: 10 mins
      }
      else
      {
        BackoffTimer = NO_BACKOFF // No Back-off, reliable Link: Back off
timer is 0
      }
    }
```

The back-off timer may be used in the OS platform to delay any application accessing data.

Without the link reliability function, the cellular device may continue to attempt to transfer data over the best available cellular connection and maintain connectivity services. However, this can lead to fast and early battery drain. By monitoring the condition of the network conditions and controlling network transfers from a higher layer, battery life can be extended while minimizing degradation of the services running on the device.

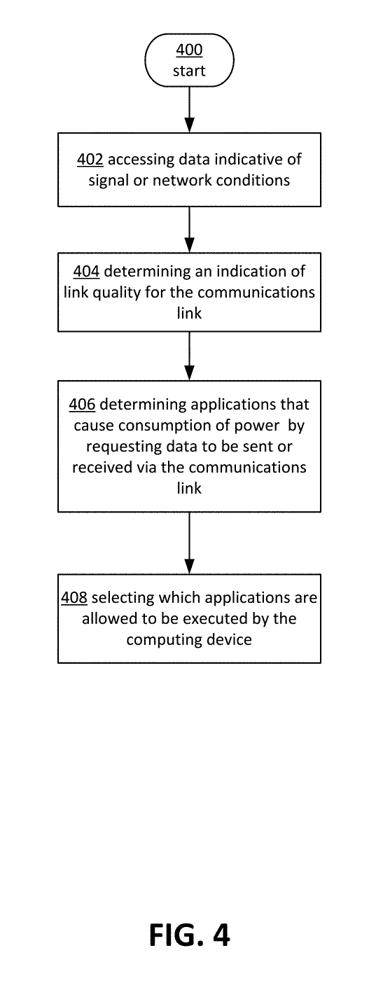

FIG. 4 depicts an exemplary operational procedure for managing power usage on a computing device including operations 400, 402, 404, and 406. Referring to FIG. 4, operation 400 begins the operational procedure and operation 402 illustrates accessing data indicative of signal or network conditions. The accessed data may comprise data indicative of signal quality, transmission statistics, network transitions, temperature, battery levels, charging state, time of day, or a combination thereof. The signal or network conditions may be for a network for which the computing device is communicatively coupled via a communications link.

Operation 404 illustrates determining an indication of link quality for the communications link. Operation 406 illustrates determining applications executing on the computing device that cause consumption of power by the computing device by requesting data to be sent or received via the communications link. Operation 408 illustrates selecting, based on the indication of link quality, which applications are allowed to be executed by the computing device. The applications may be selected so as to reduce power consumed by the computing device when the selected applications request data to be sent or received via the communications link. In some embodiments, the applications may be selected based on the priority of the applications.

In some embodiments, the indication of link quality can comprise a determination of link reliability on physical and data link layers of the communications link. Additionally or optionally, the indication of link quality can comprise a determination of data connection stability at IP layers of the communications link.

In some embodiments, a network access back-off may be implemented that is based on the indication of link quality.

In some embodiments, a notification indicative of the indication of link quality may be provided. Additionally and optionally, an interface operable to allow a user to select one or more options for response may be provided. The interface may also be configured to allow an option to override the selection of applications.

In some embodiments, the indication of link quality comprises one of a first category indicative that the communications link is highly reliable and that network disconnects are not anticipated, a second category indicative that the communications link is moderately reliable and that some network disconnects can be expected, a third category indicative that the communications link is unreliable and that a disconnect can be expected at any time, and a fourth category indicative that the communications link should not be established.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

1. A method for managing power usage on a computing device, the method comprising:
monitoring data indicative of signal or network conditions for a network for which the computing device is communicatively coupled via a wireless communications link;
based on the monitored data, determining an indication of link quality for the wireless communications link;
determining priorities of applications, respectively, executing on the computing device that cause consumption of power by the computing device by sending and/or receiving data via the communications link; and
selecting which applications are allowed to be executed by the computing device based on the indication of link quality and based on the priorities of the applications, wherein the applications are selected to reduce consumption of power by the computing device, wherein the indication of link quality changes with variation of the data indicative of signal or network conditions, and wherein which applications are selected to be allowed to be executed changes in correspondence with the changes of the indication of link quality such that the data indicative of signal or network conditions controls which applications are selected to be allowed to be executed.

2. The method of claim 1, wherein the indication of link quality comprises a determination of link reliability on physical and data link layers of the communications link.

3. The method of claim 1, wherein the indication of link quality comprises a determination of data connection stability at IP (Internet Protocol) layers of the communications link.

4. (canceled)

5. (canceled)

6. The method of claim 1, wherein the data indicative of signal or network conditions comprises transmission statistics, network transitions, temperature, battery levels, charging state, time of day, or a combination thereof.

7. The method of claim 1, further comprising providing a notification indicative of the indication of link quality.

8. The method of claim 1, further comprising providing an interface operable to allow a user to select one or more options for response.

9. The method of claim 1, further comprising displaying a user interface, wherein the user interface is configured to allow interactive overriding of the selecting of applications.

10. The method of claim 1, wherein the indication of link quality is in one of:
a first category indicating that the communications link is reliable and that network disconnects are unlikely,
a second category indicating that the communications link is less reliable than the first category and that network disconnects are more likely than the first category,
a third category indicating that the communications link is unreliable and that disconnects are more likely than the second category, and
a fourth category indicating that the communications link are not be established.

11. A computing device configured to manage power usage, the system comprising:
at least one processor; and
at least one memory communicatively coupled to said at least one processor when the computing device is operational, the memory having stored therein computer-executable instructions that, upon execution by the processor, cause:
executing of an operating system that manages the execution of applications.
accessing metrics data comprising measures of signal or network conditions for a network for which the computing device is communicatively coupled via a wireless communications link;
computing a link quality value the communications link from the accessed metrics, the link quality value corresponding to link quality of the communications link; and
based on the determined link quality value, adjusting a network access back-off time for data requests, the back-off time used by the operating system to delay transmission of data over the wireless communication link for any arbitrary requesting application.

12. The computing device of claim 11, wherein the determined link quality value comprises an indication of a first category indicative that the communications link is highly reliable and that network disconnects are not anticipated, a second category indicative that the communications link is moderately reliable and that some network disconnects can be expected, a third category indicative that the communications link is unreliable and that a disconnect can be expected at any time, or a fourth category indicative that the communications link should not be established.

13. (canceled)

14. The computing device of claim 11, wherein the accessed metrics data comprises data indicative of signal quality, transmission statistics, network transitions, temperature, battery levels, charging state, time of day, or a combination thereof.

15. The computing device of claim 11, further comprising computer-executable instructions that, upon execution by the processor, cause displaying a user interface indicating the link quality value.

16. The computing device of claim 11, further comprising computer-executable instructions that, upon execution by the processor, cause providing an interface operable to allow a user to select one or more options for response.

17. The computing device of claim 16, wherein the interface is configured to allow an option to override the selection of applications.

18. A computing device configured to:
access data indicative of signal or network conditions for a network for which the computing device is communicatively coupled via a wireless communications link, the data comprising transmission statistics collected by the computing device in conjunction with managing the wireless communication link, the transmission statistics collected at the physical, data link, transmission, and/or network layers, the transmission statistics measuring actual performance of the communications link;
computing a link quality value to represent a level of quality for the communications link, the link quality value computed from the accessed data indicative of signal or network conditions;
executing applications on the computing device, the applications having respective priorities, the applications configured to communicate via the communications link; and
determining which of the applications are to be allowed to operate using the communications link based on the computed link quality value and the priorities of the applications, wherein the priorities of the applications are evaluated against the computed link quality value to determine which of the applications are to be allowed to operate using the communications link.

19. The computing device of claim 18, wherein the link quality comprises an indication of a first category indicative that the communications link is highly reliable and that network disconnects are not anticipated, a second category indicative that the communications link is moderately reliable and that some network disconnects can be expected, a third category indicative that the communications link is unreliable and that a disconnect can be expected at any time, or a fourth category indicative that the communications link should not be established.

20. The computing device of claim 18, wherein the accessed data comprise data indicative of signal quality, transmission statistics, network transitions, temperature, battery levels, charging state, time of day, or a combination thereof.
